(19) United States
(12) Patent Application Publication
(10) Pub. No.: US 2025/0062927 A1
(43) Pub. Date: Feb. 20, 2025

(54) APPARATUS AND METHOD TO START AN ONLINE MEETING

(71) Applicant: CANON U.S.A., INC., Melville, NY (US)

(72) Inventor: Shingo Murata, Mineola, NY (US)

(21) Appl. No.: 18/807,323

(22) Filed: Aug. 16, 2024

Related U.S. Application Data
(60) Provisional application No. 63/520,468, filed on Aug. 18, 2023.

(51) Int. Cl. H04L 12/18; G06V 40/20

(52) U.S. Cl. CPC H04L 12/1822; G06V 40/20

(57) ABSTRACT

An apparatus is provided that includes at least one memory storing instructions and at least one processor that, upon execution of the instructions stored in at least the one memory, is configured to access to a server to inquire status information of an online meeting with a meeting ID, receive the status information which shows if the online meeting is running or not from the server, select a room for starting the online meeting in a case where the online meeting is not running, receive access information to a meeting control apparatus corresponding to the selected room, and send the meeting ID to the meeting control apparatus so that the meeting control apparatus performs a verification process to check if a person is in the selected room or not to start the online meeting with the meeting ID.

### CROSS-REFERENCE TO RELATED APPLICATIONS

This application claims priority from U.S. Provisional Patent Application Ser. No. 63/520,468 filed on Aug. 18, 2023, the entirety this application is incorporated herein by reference.

### FIELD

The present disclosure relates to online meeting applications and, more specifically, a mechanism for initiating an online meeting.

### DESCRIPTION OF RELATED ART

Online meetings between users is known including when a group of individuals at one location are communicating remotely with one or more individuals not presently located at the one location. In the case of an online meeting between individuals at an office in a particular meeting room and remote users (e.g. users at home), a camera is provided at the particular meeting room so that the remote users can see the individuals and objects in the particular meeting room. To start the online meeting as planned, it is encouraged that a meeting organizer makes a reservation of the particular meeting room. However, the meeting organizer and other meeting attendees sometimes encounter the situation that the reserved meeting room is unavailable even though the meeting organizer made the reservation in advance.

### SUMMARY

A system, a method, and an apparatus according to the present disclosure remedies the drawbacks associated with current online meeting solutions to improve usability in a case where the reserved meeting room is unavailable.

According to an aspect of the disclosure, a system for starting an online meeting is provided. the system includes a client, a server, and a meeting control apparatus configured to control an image capture apparatus in a room. the client is configured to access to the server to inquire status information of the online meeting with a meeting ID. the server is configured to provide the status information which shows if the online meeting is running or not to the client. the server is configured to provide access information, to the meeting control apparatus corresponding to a room selected by the client, to the client in a case where the online meeting is not running. the client is configured to access to the meeting control apparatus based on the access information provided by the server. the client is configured to send the meeting ID to the meeting control apparatus so that the meeting control apparatus can start the online meeting with the meeting ID. the meeting control apparatus is configured to perform a verification process to check if a person is in the selected room or not. the meeting control apparatus is configured to start the online meeting with the meeting ID and send an image captured by the image capture apparatus in the selected room to the server after the verification process is passed.

### BRIEF DESCRIPTION OF THE DRAWINGS

FIG. 1 is a drawing illustrating a system architecture.

FIG. 2 is a block diagram illustrating a hardware architecture.

FIGS. 3A & 3B is a flow diagram illustrating the processing steps performed when scheduling a meeting.

FIG. 4A is an example of a room list screen.

FIG. 4B is an example of a lobby screen.

FIG. 4C is an example of a room selection screen.

FIG. 4D is an example of a verification screen.

FIG. 4E is another example of a verification screen.

FIG. 4F is an example of a screen showing a verification code.

FIG. 5 is a flow diagram illustrating the processing steps performed when performing an “ad hoc start” for a meeting.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

### <System Architecture>

Exemplary embodiments of the present disclosure will be described in detail below with reference to the accompanying drawings. The following exemplary embodiments are merely examples for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

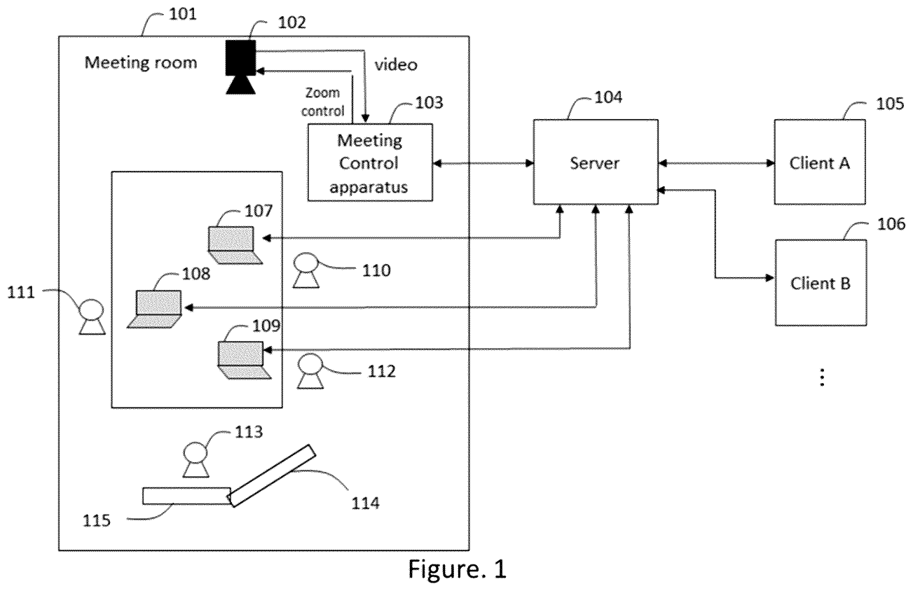

FIG. 1 illustrates a system architecture according to an exemplary embodiment. The system includes an image capture apparatus (a camera) 102, a meeting control apparatus 103, a server 104, a client computer A 105, a client computer B 106 and communication apparatuses 107-109. The communication apparatuses 107-109 can be a laptop computer, a tablet computer, a smartphone or other type of computer and are operated by respective attendees 110-112.

As illustrated in FIG. 1, the client computer A 105 and the client computer B 106 connect to, via a communication network, an online meeting held in the meeting room 101. In the present embodiment, the image capture apparatus 102, the meeting control apparatus 103, the communication apparatuses 107-109, the attendees 110-112, a presenter 113 and white boards 114-115 can be present in the meeting room 101, but this is not seen to be limiting. In another exemplary embodiment, for example, the functionality provided by the meeting control apparatus 103 as described below can be located in the cloud.

The meeting control apparatus 103 includes all the local modules, such as gesture recognition module, image capturing apparatus control module (pan/tilt/zoom), and meeting state management module. The server 104 manages meeting resources, and communication/synchronization between clients and modules included in the meeting control apparatus 103.

The image capture apparatus 102 captures video in the meeting room 101 while a meeting is in progress. The image capture apparatus 102 captures gestures by the attendees 110-112 and the presenter 113. The captured video is transmitted to the meeting control apparatus 103. As described above, the meeting control apparatus 103 can recognize user's gesture included in the video, and execute the process corresponding to the gesture.

Once the online meeting starts, the client computer A 105 and the client computer B 106 can display the video captured by the image capture apparatus 102 so that remote attendees can view what is going on in the meeting room 101, including anything that may be written on the white boards 114-115. The communication apparatuses 107-109 can display the same video so that attendees 110-112 are able to view what the remote attendees are viewing.

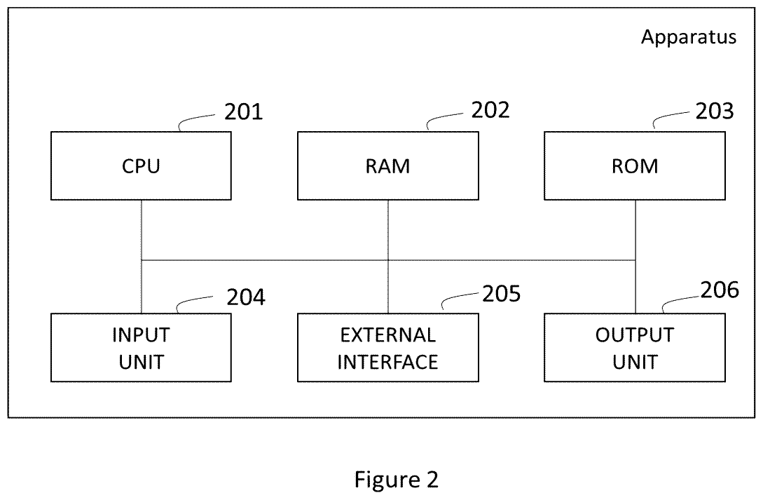

FIG. 2 illustrates a hardware architecture according to an exemplary embodiment that represents the hardware architecture of the image capture apparatus 102, the meeting control apparatus 103, the server 104 and the communication apparatuses 107-109. The hardware architecture includes a CPU 201, a RAM 202, a ROM 203, an input unit 204, an external interface 205, and an output unit 206. For description purposes, the meeting control apparatus 103 will be referred to/used to describe the various components illustrated in FIG. 2.

The CPU 201 controls the meeting control apparatus 103 via a computer program (one or more series of stored instructions executable by the CPU 201) and data stored in the RAM 202 or ROM 203. The meeting control apparatus 103 can include one or more dedicated hardware or a graphics processing unit (GPU), which is different from the CPU 201, and the GPU or the dedicated hardware can perform a part of the processes by the CPU 201. As an example of the dedicated hardware, there are an application specific integrated circuit (ASIC), a field-programmable gate array (FPGA), and a digital signal processor (DSP), and the like.

The RAM 202 temporarily stores the computer program or data read from the ROM 203, data supplied external from the meeting control apparatus 103 via the external interface 205, and the like. The ROM 203 stores the computer program and data that do not need to be modified and that can control the basic operation of the meeting control apparatus 103.

The input unit 204 is composed of, for example, a joystick, a jog dial, a touch panel, a keyboard, a mouse, or the like, receives a user operation, and inputs various instructions to the CPU 201. The external interface 205 communicates with external device such as PC, smartphone, camera and the like. The communication with the external devices can be performed via a wired interface such as a local area network (LAN) cable, a serial digital interface (SDI) cable or can performed wirelessly via a wireless interface such as Wi-Fi®, etc. Theoutput unit 206 is composed of, for example, a display unit and a sound output unit such as a speaker, and displays a graphical user interface (GUI) and outputs a guiding sound so that the user can operate the meeting control apparatus 103 as needed.

### <Methods to Start a Meeting>

In the exemplary embodiment, a user can choose two methods to start a meeting. One is “Schedule a meeting” and the other is “Ad hoc start”. The details will be described below respectively. Each of these include processing steps performed by one or more processors that execute stored computer readable and executable sets of instructions using the hardware architecture described herein

### Schedule a Meeting

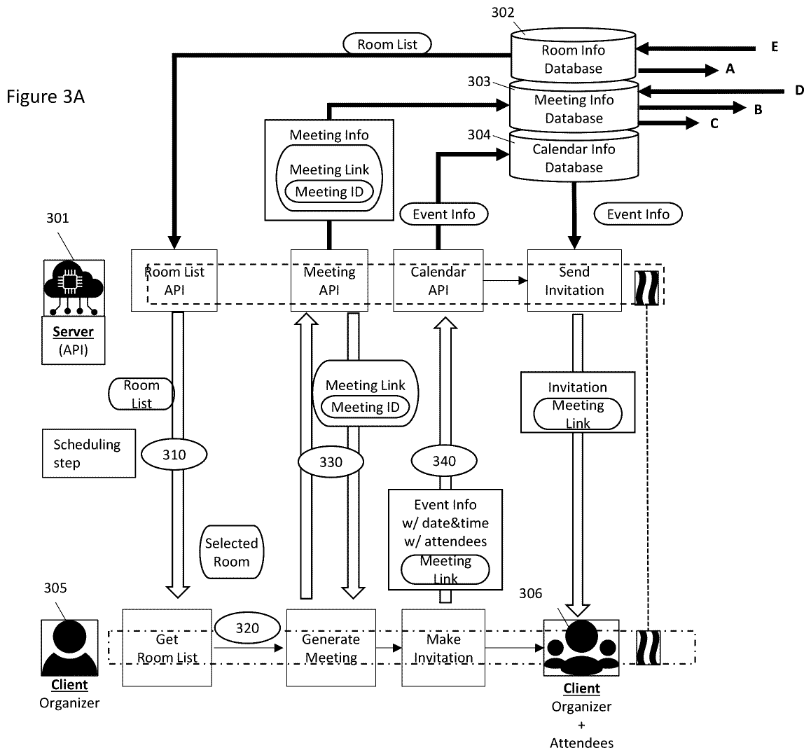

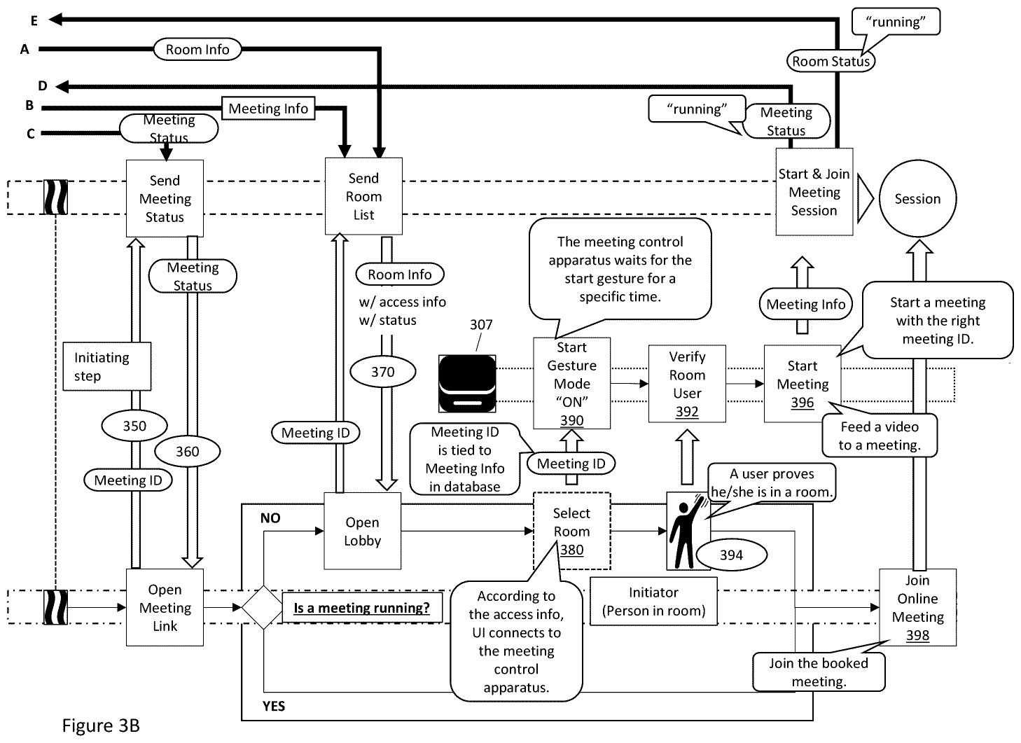

FIG. 3 illustrates a flow diagram representing the processing steps associated with the “Schedule a meeting” process. “Schedule a meeting” is a method to start an online meeting by making a reservation for the online meeting. With this method, an organizer can let attendees know when and where the online meeting will be held beforehand.

A server 301 includes Room Info Database 302, Meeting Info Database 303, and Calendar Info Database 304. Room Info Database 302 stores “Room Info” which includes “Room List” and “Room Status”. “Room List” is a list of meeting rooms equipped with the system illustrated in FIG. 1. “Room Status” is status information which shows if the meeting room is used or not. Meeting Info Database 303 stores “Meeting Info” which includes “Meeting Link”, “Meeting ID” and “Meeting Status”. “Meeting Link” is an URL to connect to an online meeting. “Meeting ID” is a number or character assigned to an online meeting to distinguish it from others. “Meeting Status” is status information which shows if an online meeting is running or not. Calendar Info Database 304 stores “Event Info” which shows when and where an online meeting will be held. “Event Info” also shows attendees of an online meeting. “Event Info” is tied to “Meeting Link”. Information stored in each database can be acquired and updated by an instruction from the server 301.

The server 301 corresponds to the server 104 in FIG. 1. A client 305 corresponds to one of the communication apparatuses 107-109 for an organizer in FIG. 1. A client 306 corresponds to one of the client computer A 105, the client computer B 106, and the communication apparatuses 107-109 for attendees in FIG. 1. A meeting control apparatus 307 corresponds to the meeting control apparatus 103 in FIG. 1.

The algorithm illustrated in FIG. 3 is divided into two steps. FIG. 3A illustrates the processing performed in the first step which is a scheduling step and FIG. 3B illustrates the processing performed in the second step which is an initiating step. The scheduling step should be done by the organizer before an online meeting starts. This step also can be called a reservation step. The initiating step is performable by anyone who is invited to a meeting. Both the organizer and any of the attendees can initiate an online meeting. The initiating step includes a conditional branch to determine if an online meeting is running or not and these flows will be separated according to the determination result.

The details of each step will be explained as follows by referencing an index number for each process corresponds to an index number in FIGS. 3A and 3B.

### [Scheduling Step]

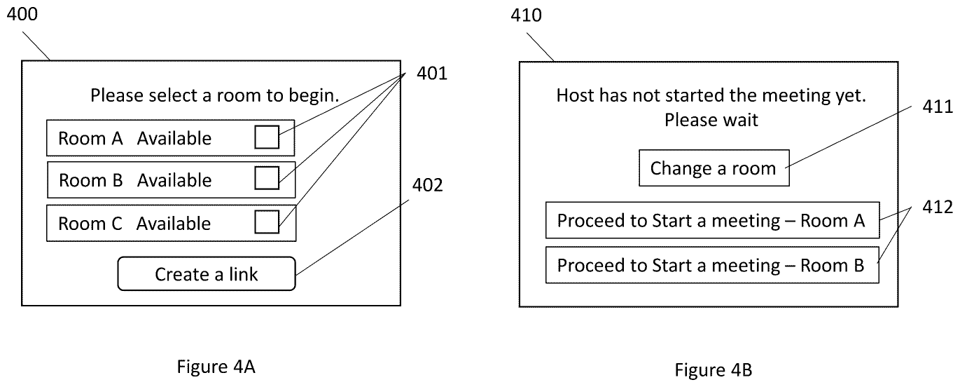

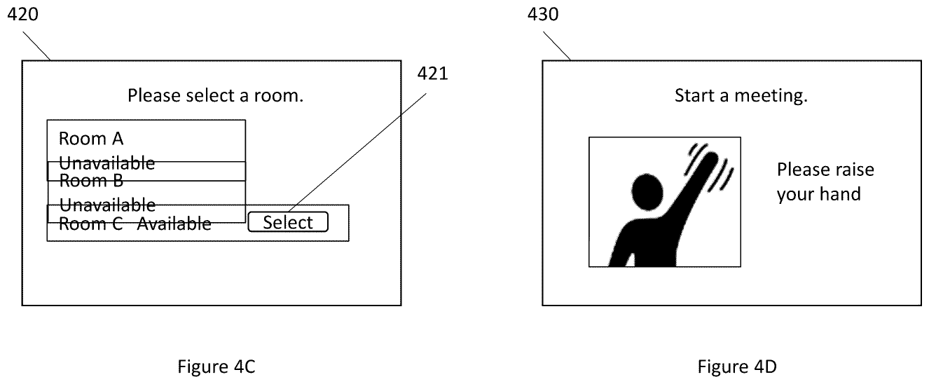

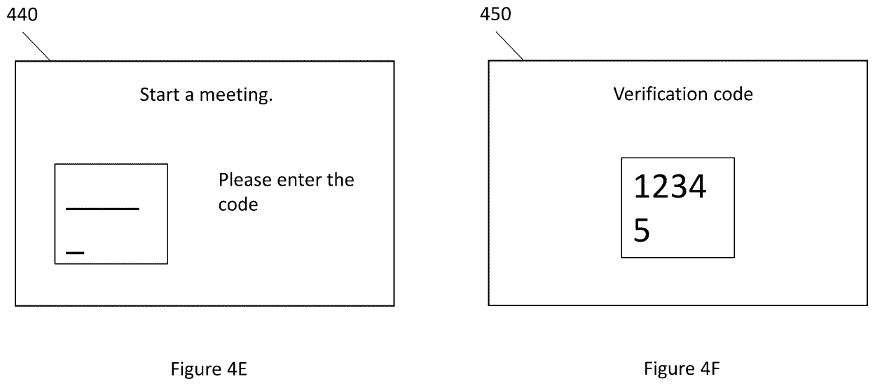

In step 310, an organizer is using the client 305. The client 305 accesses to the server 301 and obtains “Room List” from the Room Info Database 302 through the server 301. The client 305 generates data representing “Room List” and causes the generated room list data to be displayed on a display. FIG. 4A illustrates an example of a room list screen 400.

In step 320, the organizer selects a room among “Room List”. By clicking a check box 401 in FIG. 4A, the organizer can select the room for a meeting. The organizer can pick multiple rooms at this stage. Then, the organizer selects user selectable image element representing a button to create a link 402 in FIG. 4A.

In step 330, the client 305 sends information of selected rooms to the server 301. The server 301 generates “Meeting ID” for the online meeting and inserts the generated Meeting ID into a “Meeting Link”. The server 301 registers “Meeting Info” to Meeting Info Database 303 in a state where the online meeting is associatede with the selected rooms. “Meeting Info” includes “Meeting ID”, “Meeting Link”, and a list of the one or more rooms selected by the user. The server 301 communicates the “Meeting Link” back to the client 305.

In step 340, the organizer schedules a meeting. The organizer sets dates and time, and attendees to “Event Info”. The organizer selectively appends the “Event Info” with the returned “Meeting Link” and sends (or otherwise communicates) “Event Info” to the server 301. The server 301 stores “Event Info” in Calendar Info Database 304.

Once the server 301 creates a meeting event, the server 301 sends an invitation to all attendees. This step can be performed by other schedule management applications (calendar management applications). The remaining processing will be described hereinafter with respect to FIG. 3B that describes the processing associated with the initiating step.

### [Initiating Step]

In step 350, an initiator (organizer or attendee) clicks “Meeting Link” in the invitation and the client 306 accesses to the server 301 to inquire the status of an online meeting with “Meeting ID”.

In step 360, the server 301 checks the status of the online meeting by determining whether or not the meeting associated with the “Meeting ID” is running or is not running based on “Meeting Status” stored in the Meeting Info Database 303 and sends the status information to the client 306. If the determination indicates that the online meeting has not yet started, the client 306 proceeds the processing steps described in steps 370—steps 396. If the determination indicates that online meeting has already started, the client 306 skips steps 370—steps 396 and proceeds to step 398.

(Determination that Meeting is Not Running)

In step 370, the client 306 displays on a display screen a lobby screen 410 in FIG. 4B on the display if the meeting has not started yet. There are “Change a room” button 411 and “Proceed to start a meeting” button 412. The booked room (Room A, Room B) is shown in the lobby screen 410. If the booked room is already used, the initiator can change a room for the meeting by clicking “Change a room” button 411. If the booked room is available, the initiator can start a meeting by clicking “Proceed to start a meeting” button 412. The server 301 obtains “Room Info” from the Room Info Database 302 by accessing to the Room Info Database 302. The server 301 sends “Room Info” to the client 306. “Room Info” includes an access information (IP Address) to the meeting control apparatus 307 and status information of the meeting control apparatus 307.

In step 380, if the initiator selects “Change a room” button 411, the client 306 shows a room selection screen 420 in FIG. 4C on the display. The room selection screen 420 shows availability of each room based on “Room Info”. The room selection screen 420 is created by the client 306 and “Room Info” is provided by the server 301 to the client 306. The initiator can select different room (e.g. Room C) from the booked room. The organizer selects the button of the room which the organizer wants to start a meeting.

In step 390, The client 306 accesses to the meeting control apparatus 307 corresponding to the selected room based on the access information provided by the server 301. The client 306 sends the meeting ID to the meeting control apparatus 307 corresponding to the selected room so that the meeting control apparatus 307 can start the online meeting with the meeting ID.

In step 392, to start the online meeting, the meeting control apparatus 307 needs to verify if a user is actually present in the meeting room associated with the Meeting ID. This is to ensure security and confidentiality in the meeting room. FIG. 4D illustrates an example of a verification screen 430.

In step 394, when the initiator performs a trigger operation to indicate that the user is presently in the room, a verification process has been passed. In one embodiment, the trigger operation includes performing a predetermined gesture that is captured and authenticated by a gesture detection process. For example, the predetermined gesture may include raising a hand or makes a predetermined pose to the image capture apparatus 102 in the meeting room. For example, the image capture apparatus 102 captures the image in the meeting room and sends it to the meeting control apparatus 307. The meeting control apparatus 307 determines if a person in the meeting room makes the predetermined gesture (e.g. hand raising) based on the image. The verification process is passed in a case where the meeting control apparatus 307 determines the person makes the predetermined gesture.

In step 396, after the verification process is successful, the meeting control apparatus 307 starts the online meeting and feeds a video captured by the image capture apparatus 102. The meeting control apparatus 307 accesses to the server 301 and joins the online meeting with “Meeting ID”. Also, the client 306 accesses to the server 301 and joins the online meeting with “Meeting ID”. The client 306 shows the video fed from the meeting control apparatus 307 through the server 301 on the display of the client 306.

### (Running Case)

In step 398, the client 306 accesses to the server 301 and joins the online meeting with “Meeting ID”. The client 306 shows the video captured by the image capture apparatus 102 on the display.

In the above flow, the client 306 always shows the lobby screen 410 on the display if the online meeting has not started yet. However, it is not limited to this. If the online meeting has not started yet and the booked room is still available, the client 306 may access to the meeting control apparatus 307 in the booked room without showing the lobby screen 410. That is, after the step 360 in the initiation step, the system can skip the step 370 and step 380 in case when it is determined that the meeting is not running. The meeting control apparatus 307 in the booked room can start the verification process in the booked room and the client 306 may show the verification screen 430 just after opening “Meeting Link”.

In the above flow, the meeting control apparatus 307 verifies if someone is in the meeting room by a human gesture. However, it is not limited to this. FIG. 4E illustrates another example of a verification screen 440. In this verification method, the initiator is required to enter a verification code on the verification screen 440. FIG. 4F illustrates a screen 450 which is shown on a display connected to the meeting control apparatus 307 and located in the meeting room. If the initiator is in the meeting room, the initiator can see the verification code on the screen 450 and can enter the code in the verification screen 440. By entering the code in the verification screen 440, the verification process is passed.

In the above flow, “Meeting ID” is sent to the meeting control apparatus 307 from the client 306. The client 306 and the meeting control apparatus 307 are in the same network (LAN). The meeting control apparatus 307 accepts “Meeting ID” and a request to start the online meeting only from devices in the same network. This is to ensure security and confidentiality in the meeting room. However, it is not limited to this. “Meeting ID” and the request to start the online meeting may be sent to the meeting control apparatus 307 from the server 301. The user may select an option that the meeting control apparatus 307 accepts “Meeting ID” and the request to start the online meeting not only from the devices in the same network but also devices in different network.

### <Ad Hoc Start>

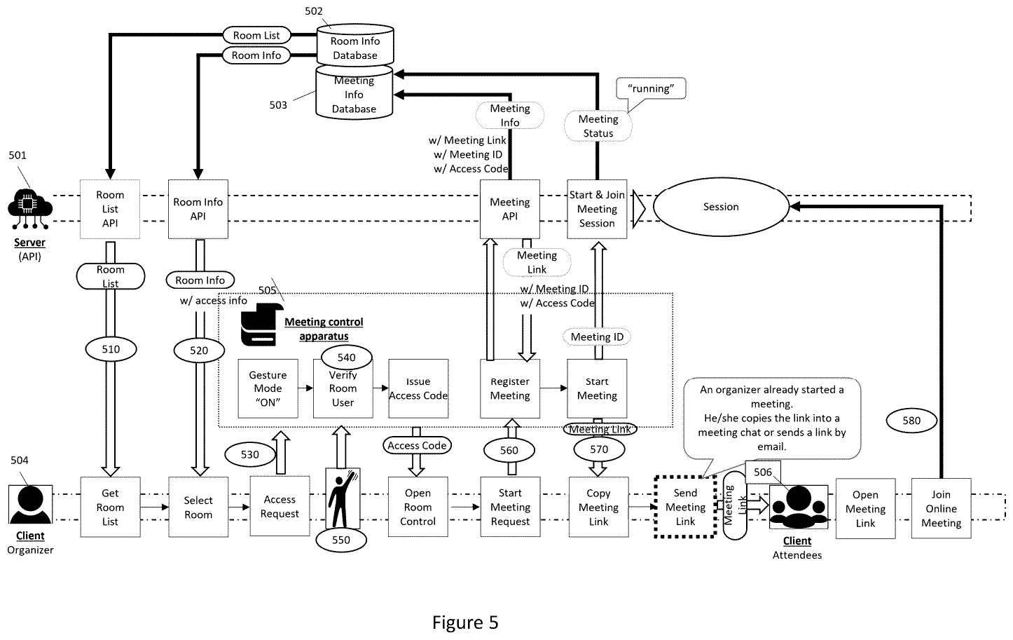

FIG. 5 illustrates an flow diagram representing the processing steps associated with the processing associated with an “Ad hoc start” for initiating a meeting. “Ad hoc start” is a method to start an online meeting without making a reservation for the online meeting. When users want to have the online meeting while they are in a meeting room equipped with the system illustrated in FIG. 1, the user can immediately start the online meeting with this method.

A server 501 includes Room Info Database 502 and Meeting Info Database 503. Room Info Database 502 stores “Room Info” which includes “Room List” and “Room Status”. “Room List” is a list of meeting rooms equipped with the system illustrated in FIG. 1. “Room Status” is status information which shows if the meeting room is used or not. Meeting Info Database 503 stores “Meeting Info” which includes “Meeting Link”, “Meeting ID” and “Meeting Status”. “Meeting Link” is an URL to connect to an online meeting. “Meeting ID” is a number or character assigned to an online meeting to distinguish it from others. “Meeting Status” is status information which shows if an online meeting is running or not.

The server 501 corresponds to the server 104 in FIG. 1. A client 504 corresponds to one of the communication apparatuses 107-109 for an organizer in FIG. 1. A client 506 corresponds to one of the client computer A 105, the client computer B 106, and the communication apparatuses 107-109 for attendees in FIG. 1. A meeting control apparatus 505 corresponds to the meeting control apparatus 103 in FIG. 1.

The details of each step will be explained as follows. An index number for each process corresponds to an index number in FIG. 5.

In step 510 an organizer is using the client 504. The client 504 accesses to the server 501 and obtains “Room List” from the Room Info Database 502 through the server 501. The client 504 shows “Room List” on a display. FIG. 4C illustrates an example of a room selection screen 420.

In step 520, the organizer selects a room among “Room List”. By clicking a select button 421 in FIG. 4C, the organizer can select the room for a meeting. The server 501 provides an access information (IP address) to the meeting control apparatus 505 corresponding to the selected room.

In step 530, the client 504 issues an access request to the meeting control apparatus 505 corresponding to the selected room based on the access information provided by the server 501.

In step 540, to start the online meeting, the meeting control apparatus 505 needs to verify if someone is in the meeting room. This is to ensure security and confidentiality in the meeting room. FIG. 4D illustrates an example of a verification screen 430.

In step 550, when the organizer raises a hand or makes a predetermined gesture to the image capture apparatus 102 in the meeting room, a verification process is passed. 560 After the verification process is passed, the client 504 obtains a right to control the online meeting. The client 504 issues a request to start a meeting to the meeting control apparatus 505. 570 The meeting control apparatus 505 starts an online meeting in response to the request from the client 504. The meeting control apparatus 505 provides “Meeting Link” to the client 504. The organizer can send an invitation with “Meeting Link” to the attendees. 580 The attendees receive the invitation with “Meeting Link”. When the attendees open “Meeting Link”, the client 506 is connected to the server 501 to join the online meeting.

In the above flow, the meeting control apparatus 505 verifies if someone is in the meeting room by a human gesture. However, it is not limited to this. FIG. 4E illustrates another example of a verification screen 440. In this verification method, the initiator is required to enter a verification code on the verification screen 440. FIG. 4F illustrates a screen 450 which is shown on a display connected to the meeting control apparatus 307 and located in the meeting room. If the organizer is in the meeting room, the organizer can see the verification code on the screen 450 and can enter the code in the verification screen 440. By entering the code in the verification screen 440, the verification process is passed.

According to the above disclosure, a system and method for starting an online meeting, the system comprising a client, a server, and a meeting control apparatus configured to control an image capture apparatus in a room is provided. In the system, the client is configured to access to the server to inquire status information of the online meeting with a meeting ID, the server is configured to provide the status information which shows if the online meeting is running or not to the client. The server is configured to provide access information, to the meeting control apparatus corresponding to a room selected by the client, to the client in a case where the online meeting is not running. The client is further configured to access to the meeting control apparatus based on the access information provided by the server and send the meeting ID to the meeting control apparatus so that the meeting control apparatus can start the online meeting with the meeting ID. The meeting control apparatus is configured to perform a verification process to check if a person is in the selected room or not, and to start the online meeting with the meeting ID and send an image captured by the image capture apparatus in the selected room to the server after the verification process is passed.

In one embodiment, the verification process includes that the client is configured to show a verification screen on a display of the client to notify the person to make a predetermined gesture and the meeting control apparatus is configured to obtain the image captured by the image capture apparatus and determine if the person makes the predetermined gesture based on the image, and wherein the verification process is passed in a case where the meeting control apparatus determines the person makes the predetermined gesture.

In another embodiment, the meeting control apparatus is configured to show a screen on a display located in the selected room, the screen showing a verification code and the client is configured to show a verification screen on a display of the client to notify the person to enter the verification code into the verification screen, and send an entered code to the meeting control apparatus, and the verification process is passed in a case where the entered code matches the verification code.

In another embodiment, the client is configured to access to the server to obtain a room list and to select a predetermined room among the room list to make a reservation for the online meeting, and the server is configured to generate the meeting ID for the online meeting which is associated with the predetermined room. In certain instances, the system the client is configured to show a lobby screen on a display of the client in the case where the online meeting is not running, the lobby screen showing a button to change a room from the predetermined room and the server is configured to provide the access information, to the meeting control apparatuses corresponding to other rooms than the predetermined room, to the client in a case where the button is clicked, and the client is configured to show a selection screen to select the room which is different from the predetermined room on the display of the client, the selection screen showing a list of the other rooms. In other instances, the client is configured to show a lobby screen on a display of the client in the case where the online meeting is not running, the lobby screen showing a button to initiate the online meeting which is associated with the predetermined room, the client is configured to access to the meeting control apparatus corresponding to the predetermined room and sending the meeting ID to the meeting control apparatus so that the meeting control apparatus can start the online meeting with the meeting ID, the meeting control apparatus is configured to perform the verification process to check if the person is in the predetermined room or not, and the meeting control apparatus is configured to start the online meeting with the meeting ID and sending an image captured by the image capture apparatus in the predetermined room to the server after the verification process is passed.

In another embodiment, an apparatus is provided and includes at least one memory storing instructions; and at least one processor that, upon execution of the instructions stored in at least the one memory. The apparatus is configured to access to a server to inquire status information of an online meeting with a meeting ID, receive the status information which shows if the online meeting is running or not from the server, select a room for starting the online meeting in a case where the online meeting is not running, receive access information to a meeting control apparatus corresponding to the selected room, and send the meeting ID to the meeting control apparatus so that the meeting control apparatus performs a verification process to check if a person is in the selected room or not to start the online meeting with the meeting ID.

In another embodiment, the apparatus is further configured to show a verification screen on a display of the client to notify the person to make a predetermined gesture, wherein the verification process is passed in a case where the meeting control apparatus determines the person makes the predetermined gesture.

In another embodiment, the apparatus is configured to show a verification screen on a display of the client to notify the person to enter a verification code into the verification screen, and send an entered code to the meeting control apparatus, and wherein the verification process is passed in a case where the entered code matches the verification code.

In other embodiments, the apparatus is further configured to access to the server to obtain a room list, select a predetermined room among the room list to make a reservation for the online meeting, and receive the meeting ID, generated by the server, for the online meeting which is associated with the predetermined room.

In other embodiments, the apparatus is configured show a lobby screen on a display of the client in the case where the online meeting is not running, the lobby screen showing a button to change a room from the predetermined room, receive the access information, to the meeting control apparatuses corresponding to other rooms than the predetermined room, from the server in a case where the button is clicked, and show a selection screen to select the room which is different from the predetermined room on the display of the client, the selection screen showing a list of the other rooms.

Further embodiments of the apparatus include being configured to show a lobby screen on a display of the client in the case where the online meeting is not running, the lobby screen showing a button to initiate the online meeting which is associated with the predetermined room, access to the meeting control apparatus corresponding to the predetermined room and send the meeting ID to the meeting control apparatus so that the meeting control apparatus performs the verification process to check if the person is in the selected room or not to start the online meeting with the meeting ID.

It should be understood that any of the above described configurations and embodiments, may be combined in any manner and the scope of the invention according to the present disclosure contemplates the various different embodiments.

While different exemplary embodiments have been described, respective features of each of these exemplary embodiments can be combined in accordance with the principles of the disclosure therein. As such, the above descriptions are intended to clearly describe the principles of each exemplary embodiment and skilled artisans would be able to combine respective features of one or more of the exemplary embodiments and combine them with features of any of the other exemplary embodiments.

The scope of the present disclosure includes a non-transitory computer-readable medium storing instructions that, when executed by one or more processors, cause the one or more processors to perform one or more exemplary embodiments of the present disclosure. Examples of a computer-readable medium include, but are not limited to, a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can be supplied to the computer-readable storage medium via download via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

The present disclosure can be incorporated in the form of a variety of embodiments, only a few of which are disclosed herein. Variations of those embodiments may become apparent to those of ordinary skill in the art upon reading the foregoing description. Accordingly, this disclosure and any embodiments derived therefrom includes all modifications and equivalents of the subject matter recited in the claims appended hereto as permitted by applicable law. Any combination of the above-described elements in all possible variations thereof is encompassed by the disclosure unless otherwise indicated herein or otherwise clearly contradicted by context.

We claim:

1. A system for starting an online meeting, the system comprising a client, a server, and a meeting control apparatus configured to control an image capture apparatus in a room, wherein,
the client is configured to access to the server to inquire status information of the online meeting with a meeting ID,
the server is configured to provide the status information which shows if the online meeting is running or not to the client,
the server is configured to provide access information, to the meeting control apparatus corresponding to a room selected by the client, to the client in a case where the online meeting is not running,
the client is configured to access to the meeting control apparatus based on the access information provided by the server,
the client is configured to send the meeting ID to the meeting control apparatus so that the meeting control apparatus can start the online meeting with the meeting ID,
the meeting control apparatus is configured to perform a verification process to check if a person is in the selected room or not, and
the meeting control apparatus is configured to start the online meeting with the meeting ID and send an image captured by the image capture apparatus in the selected room to the server after the verification process is passed.

2. The system according to claim 1, wherein the verification process includes:
the client is configured to show a verification screen on a display of the client to notify the person to make a predetermined gesture,
the meeting control apparatus is configured to obtain the image captured by the image capture apparatus and determine if the person makes the predetermined gesture based on the image, and
wherein the verification process is passed in a case where the meeting control apparatus determines the person makes the predetermined gesture.

3. The system according to claim 1, wherein the verification process includes:
the meeting control apparatus is configured to show a screen on a display located in the selected room, the screen showing a verification code,
the client is configured to show a verification screen on a display of the client to notify the person to enter the verification code into the verification screen, and
the client is configured to send an entered code to the meeting control apparatus, and
wherein the verification process is passed in a case where the entered code matches the verification code.

4. The system according to claim 1, wherein,
the client is configured to access to the server to obtain a room list;
the client is configured to select a predetermined room among the room list to make a reservation for the online meeting, and
the server is configured to generate the meeting ID for the online meeting which is associated with the predetermined room.

5. The system according to claim 4, wherein,
the client is configured to show a lobby screen on a display of the client in the case where the online meeting is not running, the lobby screen showing a button to change a room from the predetermined room;
the server is configured to provide the access information, to the meeting control apparatuses corresponding to other rooms than the predetermined room, to the client in a case where the button is clicked, and
the client is configured to show a selection screen to select the room which is different from the predetermined room on the display of the client, the selection screen showing a list of the other rooms.

6. The system according to claim 4, wherein,
the client is configured to show a lobby screen on a display of the client in the case where the online meeting is not running, the lobby screen showing a button to initiate the online meeting which is associated with the predetermined room;
the client is configured to access to the meeting control apparatus corresponding to the predetermined room and sending the meeting ID to the meeting control apparatus so that the meeting control apparatus can start the online meeting with the meeting ID;
the meeting control apparatus is configured to perform the verification process to check if the person is in the predetermined room or not, and
the meeting control apparatus is configured to start the online meeting with the meeting ID and sending an image captured by the image capture apparatus in the predetermined room to the server after the verification process is passed.

7. A method for starting an online meeting with a client, a server, and a meeting control apparatus configured to control an image capture apparatus in a room, the method comprising:
accessing to the server to inquire status information of the online meeting with a meeting ID;
providing the status information which shows if the online meeting is running or not to the client;
providing access information, to the meeting control apparatus corresponding to a room selected by the client, to the client in a case where the online meeting is not running;
accessing to the meeting control apparatus corresponding to the selected room based on the access information provided by the server;
sending the meeting ID to the meeting control apparatus so that the meeting control apparatus can start the online meeting with the meeting ID;
performing a verification process to check if a person is in the selected room or not, and
starting the online meeting with the meeting ID and sending an image captured by the image capture apparatus in the selected room to the server after the verification process is passed.

8. The method according to claim 7, wherein the verification process includes:
showing a verification screen on a display of the client to notify the person to make a predetermined gesture;
obtaining the image captured by the image capture apparatus and determining if the person makes the predetermined gesture based on the image, and
wherein the verification process is passed in a case where the meeting control apparatus determines the person makes the predetermined gesture.

9. The method according to claim 7, wherein the verification process includes:
showing a screen on a display located in the selected room, the screen showing a verification code;
showing a verification screen on a display of the client to notify the person to enter the verification code into the verification screen, and
sending an entered code to the meeting control apparatus, and
wherein the verification process is passed in a case where the entered code matches the verification code.

10. The method according to claim 7, wherein the method further comprising:
accessing to the server to obtain a room list;
selecting a predetermined room among the room list to make a reservation for the online meeting, and
generating the meeting ID for the online meeting which is associated with the predetermined room.

11. The method according to claim 10, wherein the method further comprising:
showing a lobby screen on a display of the client in the case where the online meeting is not running, the lobby screen showing a button to change a room from the predetermined room;
providing the access information, to the meeting control apparatuses corresponding to other rooms than the predetermined room, to the client in a case where the button is clicked, and
showing a selection screen to select the room which is different from the predetermined room on the display of the client, the selection screen showing a list of the other rooms.

12. The method according to claim 10, wherein the method further comprising:
showing a lobby screen on a display of the client in the case where the online meeting is not running, the lobby screen showing a button to initiate the online meeting which is associated with the predetermined room;
accessing to the meeting control apparatus corresponding to the predetermined room and sending the meeting ID to the meeting control apparatus so that the meeting control apparatus can start the online meeting with the meeting ID;
performing the verification process to check if the person is in the predetermined room or not, and
starting the online meeting with the meeting ID and sending an image captured by the image capture apparatus in the predetermined room to the server after the verification process is passed.

13. An apparatus comprising:
at least one memory storing instructions; and
at least one processor that, upon execution of the instructions stored in at least the one memory, is configured to:
access to a server to inquire status information of an online meeting with a meeting ID;
receive the status information which shows if the online meeting is running or not from the server;
select a room for starting the online meeting in a case where the online meeting is not running;
receive access information to a meeting control apparatus corresponding to the selected room, and
send the meeting ID to the meeting control apparatus so that the meeting control apparatus performs a verification process to check if a person is in the selected room or not to start the online meeting with the meeting ID.

14. The apparatus according to claim 13, wherein at least the one processor is further configured to:
show a verification screen on a display of the client to notify the person to make a predetermined gesture,
wherein the verification process is passed in a case where the meeting control apparatus determines the person makes the predetermined gesture.

15. The apparatus according to claim 13, wherein at least the one processor is further configured to:
show a verification screen on a display of the client to notify the person to enter a verification code into the verification screen, and
send an entered code to the meeting control apparatus, and
wherein the verification process is passed in a case where the entered code matches the verification code.

16. The apparatus according to claim 13, wherein at least the one processor is further configured to:
access to the server to obtain a room list;
select a predetermined room among the room list to make a reservation for the online meeting, and
receive the meeting ID, generated by the server, for the online meeting which is associated with the predetermined room.

17. The apparatus according to claim 16, wherein at least the one processor is further configured to:
show a lobby screen on a display of the client in the case where the online meeting is not running, the lobby screen showing a button to change a room from the predetermined room;
receive the access information, to the meeting control apparatuses corresponding to other rooms than the predetermined room, from the server in a case where the button is clicked, and
show a selection screen to select the room which is different from the predetermined room on the display of the client, the selection screen showing a list of the other rooms.

18. The apparatus according to claim 16, wherein at least the one processor is further configured to:
show a lobby screen on a display of the client in the case where the online meeting is not running, the lobby screen showing a button to initiate the online meeting which is associated with the predetermined room;
access to the meeting control apparatus corresponding to the predetermined room and send the meeting ID to the meeting control apparatus so that the meeting control apparatus performs the verification process to check if the person is in the selected room or not to start the online meeting with the meeting ID.
